(19) United States
(12) Patent Application Publication
(10) Pub. No.: US 2016/0027327 A1
(43) Pub. Date: Jan. 28, 2016

(54) Toothbrush Training Game for Children

(71) Applicants: Dov Jacobson, Berkeley Lake, GA (US); Jesse Martin Jacobson, Atlanta, GA (US)

(72) Inventors: Dov Jacobson, Berkeley Lake, GA (US); Jesse Martin Jacobson, Atlanta, GA (US)

(21) Appl. No.: 14/809,902

(22) Filed: Jul. 27, 2015

Related U.S. Application Data
(60) Provisional application No. 62/028,836, filed on Jul. 25, 2014.

(51) Int. Cl. G09B 19/00; G09B 5/06

(52) U.S. Cl. CPC G09B 19/0084; G09B 5/06

(57) ABSTRACT

A tooth brushing training system that appears to be a game to children captures video of a user during tooth brushing and displays the captured video alongside an animated or recorded video illustrating the desired tooth brushing motion. An animated character with exaggerated teeth and a head that flips open may aid in illustrating the desired tooth brush position and motion, guides the user through a desired brushing routine. At the conclusion of the brushing routine, a series of screens are displayed to the user in which the user's position at a particular point in the brushing routine is shown in one quadrant while three instructional images are shown in the other quadrants. The user is asked to select the correct instructional image that corresponds to the user's displayed tooth brush position. Points are assigned for correct answers and various types of electronic rewards are provided for high scores.

### REFERENCE TO RELATED APPLICATION

This Application claims priority to commonly-owned U.S. Provisional Patent Application Ser. No. 62/028,836, entitled “Toothbrush Training Game for Children,” filed Jul. 25, 2014, which is incorporated by reference. This application also incorporates by reference U.S. patent application Ser. No. 13/961,938, Publication No. 2014-0065588.

### TECHNICAL FIELD

The present invention relates to multimedia training systems and, more particularly, to a toothbrush training system for children utilizing video capture, an instructional video, and a game scoring format that encourages children brush properly.

### BACKGROUND

Instructing and encouraging children to brush their teeth effectively can be a challenge. The usual communication methods that may be effective with adults, such as explicit verbal instruction and logical explanation of the consequences of failing to brush properly, may be less effective with children. Children lack the references and the vocabulary required for verbal explanation of the brushing process. They have not yet developed a clear mental image of the topology of their teeth, and are particularly ignorant of those surfaces they cannot easily see. Nor do children readily understand instructional phrases that employ geometric language such as “the correct angle” or “rotate your brush”. Even terms like “left side” and “right side” strain a young child's capacity for spatial abstraction.

Many children may appear to understand verbal instruction but not really comprehend and are not able to put into practice what they are expected to do. Children also tend to have short attention spans, become distracted, and forget instructions resulting in regression even after the tasks have been initially learned. Monitoring tooth brushing effectiveness can be difficult for even a skilled human instructor. Instructive repetition can be frustrating for the adult trainer and child trainee alike. Worse yet, poorly administered training can cause tooth brushing to become a frustrating, tedious or stressful experience that the child wants to avoid.

Electric toothbrushes have been developed with timers that emit a sound or employ vibrators to provide haptic feedback intended to prompt the user to brush certain tooth sections for desired time intervals. These time-keeping systems are ineffective training devices, however, because they fail to provide guidance on how the child should properly hold and move the toothbrush to implement the desired brushing technique. Nor do they provide dynamic feedback based on the user's actual brushing motion compared to the desired brushing technique.

Electronic game-like systems using electronic toothbrushes have also been developed to encourage children to brush properly by performing a game operation through brush movement. For example, the child may advance a sprite, such as an animated image of a mouse, through a maze to the location of a prize such as an image of cheese, by moving the brush through a predefined set of movements for predefined intervals. While these systems provide an effective reward for children to encourage them to complete a desired brushing routine, they presume that the children know how to hold and move the toothbrush as a prerequisite to using the game effectively. These systems fail to provide any instruction concerning the desired brushing technique or feedback concerning brush positioning, orientation, motion or pressure with respect to the desired brushing action. As a result, these systems only monitor general toothbrush movement without providing any instruction, assessment, or feedback based on performance of the desired brushing routine.

Ineffective tooth brushing by children can have the undesirable consequences of increased tooth decay, periodontal disease, bad breath, uncomfortable or even traumatic dental procedures, potential long term tooth and gum damage, and increased dental health costs. There is, therefore, a continuing need for more effective tooth brush training systems for children.

### SUMMARY

The present invention may be embodied in a tooth brushing training system that appears to be a game to children. The system captures video of a user during tooth brushing and displays the captured video alongside an animated character illustrating the desired tooth brushing motion. The animated avatar (e.g., “Mr. Molar”), which has exaggerated teeth and a head that flips open to aid in illustrating the desired tooth brush position and motion, guides the user through a desired brushing routine. At the conclusion of the brushing routine, a series of screens are displayed to the user in which the user's position at a particular point in the brushing routine is shown in one quadrant while three instructional images are shown in the other quadrants. The user is asked to select the correct instructional image of the brush stroke corresponding to his or her own image shown on the display (i.e., a “matching” type question). Several similar multiple-choice screens are displayed for different points in the brushing routine. Points are assigned for correct answers and a reward (e.g., game points, tokens, and/or a displayed celebrations) are provided for high scores.

This game approach encourages children using the system to brush properly by encouraging them to mimic the desired motion of the instructional video so that they will be able to correctly pick out the correct instructional images in the multiple-choice screens. While very successful in practice, this approach does not require instrumented tooth brushes. The system can also be implemented through software running on a conventional tablet with a built-in camera. Game scores, multiple-choice selection screens, still images of the users, and videos can be stored for parental review. The present game approach differs from prior game approaches to tooth brushing by illustrating the desired toothbrush motion with an instructional character capturing images of the user, displaying the user's actual motion alongside the desired motion demonstrated by the instructional character, and providing the scoring system described above. The instructional character may be animated or recorded, such as a parent illustrating the desired brushing motion.

Additional features and advantages may be realized through the techniques of the present invention. Other embodiments and aspects of the invention are described below and considered a part of the claimed invention. For a better understanding of the invention with the advantages and the features, refer to the description and to the drawings.

### BRIEF DESCRIPTION OF THE FIGURES

FIG. 1 is a block diagram of a system for implementing toothbrush training game for children.

FIG. 2 is a logic flow diagram for operating the toothbrush training game for children.

FIGS. 3-15 are screen shots of the toothbrush training game for children.

FIGS. 16-19 illustrate a clip-on instrumented handle for a non-instrumented toothbrush allowing it the function in an instrumented toothbrush monitoring and instructional system.

### DETAILED DESCRIPTION

The present invention may be embodied in a tooth brushing training system that appears to be a game to children.

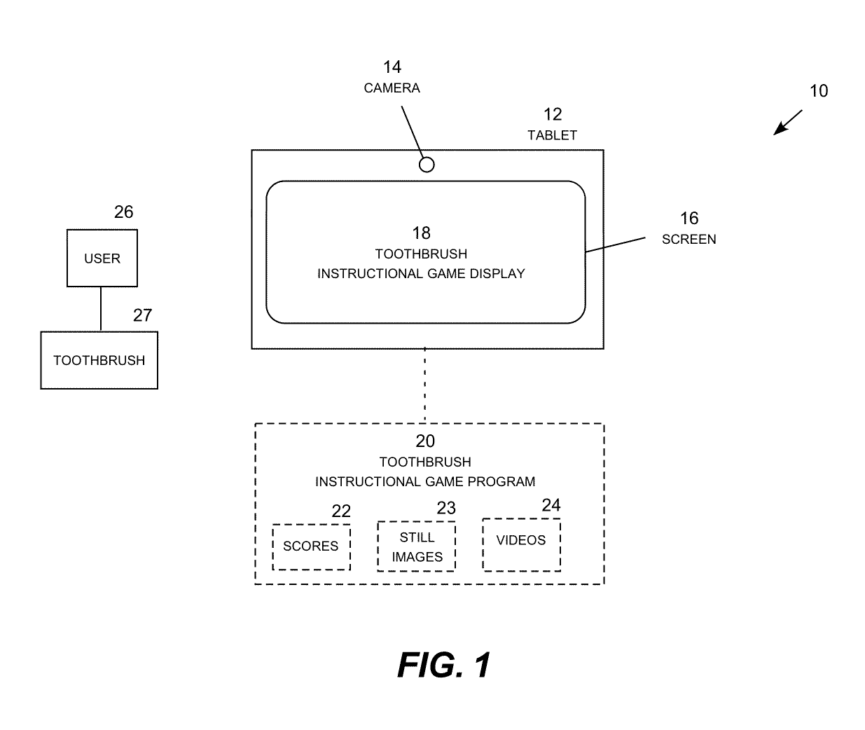

FIG. 1 is a block diagram of a system 10 for implementing a toothbrush training game for children which, in this embodiment, utilizes “Mr. Molar” as an instructional character. Although any type of computer with a display may be utilized, the system if well suited for implementation on a tablet 12 with a camera 12 and a display screen 16. A toothbrush instructional game program 20 running on the tablet 12 typically stores game scores 22, still images 22 of the user which may include comparative images of the instructional character at a corresponding point in the tooth brushing program, and videos 24 of the user that may also include the images of the instructional image at a corresponding point in the tooth brushing program.

A user 26 views the toothbrush instructional game program 20 running on the tablet 12 while brushing his or her teeth with a tooth brush 27. The camera 14 on the tablet captures a video of the user, which his displayed on the screen 16 as “picture within a picture” along with the instructional character in which Mr. Molar demonstrates the desired toot brushing motion. The tablet 12 may be supported within a stand, frame or hanger supported by or attached to the sink, wall, mirror behind the sink, or in another suitable location. It will be appreciated that this configuration can be implemented through software running on a conventional tablet and, as such, does not require a special-purpose device or instrumented toothbrush.

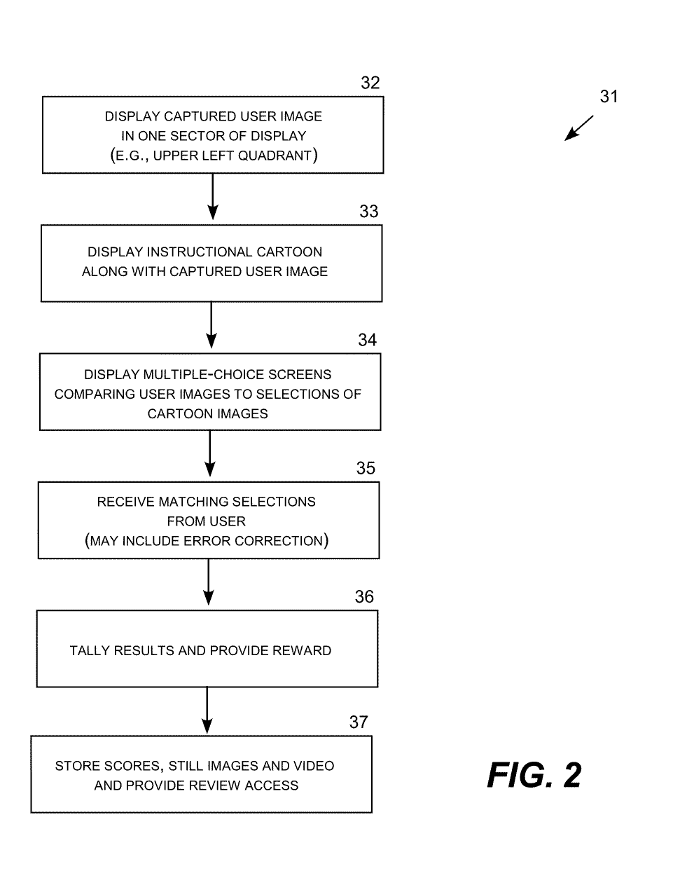

FIG. 2 is a logic flow diagram 31 for operating the toothbrush training game for children. In block 32, the tablet (or other suitable host computer) captures an image of the user, which is displayed on the display screen of the tablet. Block 32 is followed by block 33, in which an instructional character is displayed along with the image of the user captured by the camera on the tablet, for example with the user's image shown as a “picture within a picture” within or alongside the instructional character. The instructional character displays a desired brushing routine that the user (child) is intended to follow to complete the desired brushing routine. This allows the user's brushing performance to be recorded synchronously with time dependent training material such as an instructional character that the user is expected to mirror during the brushing process. Other embodiments may feature learning methods other than mimicry. In many cases it suffices for the system to record the time in order to later synchronize with instructional material. The recordings might be selected from a list of challenge points designated by instructional designers to maximize assessment value.

To provide game-like feedback after the brushing routine has run its course, block 33 is followed by block 34, in which the system presents the user with a series of multiple-choice screens comparing the user's image to selections of instructional images. Block 34 is followed by block 35, in which the system receives a “matching” selection from the user. While only one instance of blocks 34-35 are shown, it will be understood that the process is repeated for however many “matching” questions the system is configured to display. A four quadrant display provides an illustrative example in which the user's image appears in one quadrant. One of the instructional images is the character image displayed when the user's image was recorded (i.e., the instructional character demonstrating the correct brush stroke is the correct response), or another representation of that instructional moment, such as a new rendering from a more appropriate point of view, the other two (incorrect responses) correspond to different times in the program when different tooth brush strokes were being demonstrated. The user selects among the instructional images to “match” the correct instructional image with the user's brush stroke. A series of these multiple-choice screens is displayed and responses are gathered for several points in the tooth brushing routine. It will be appreciated that as an alternative, which may be selectable by the user, the correct instructional image or video or audio or other instructional content may be shown along with three images of the user at different times. In both alternatives, the user (child) is encouraged to mimic the instructional image correctly during the tooth brushing process so that he or she will be able to correctly match the images at the end of the routine to win game points.

Block 35 is followed by block 36, in which the system tallies the results and provides a reward, such as game points to tokens and/or an electronic celebration. Block 36 is followed by block 37, in which the system stores the results, such as game scores, still images and video of the user. The still images and video of the user may be stored along with the corresponding instructional images so that a reviewing parent can see how well the child followed the instructional video. While “Mr. Molar” provides an inviting character, the system may also allow a person, such as a child's parent, to record himself or herself performing the desired brushing routine. A number of other animated characters may also be provided, which can be selected by the user. This allows, for example, a female character to popular characters that the user can select.

The characters may also be organized into a hierarchy so that the child advances through the characters by scoring well in the brushing games. For example, the “level 1” character may be a child's parent, the “level 2” character may be an avatar for the child, the “level 3” character may be an attractive hero image, and so forth up an ultimate “extreme super hero” level with huge sparkling teeth.

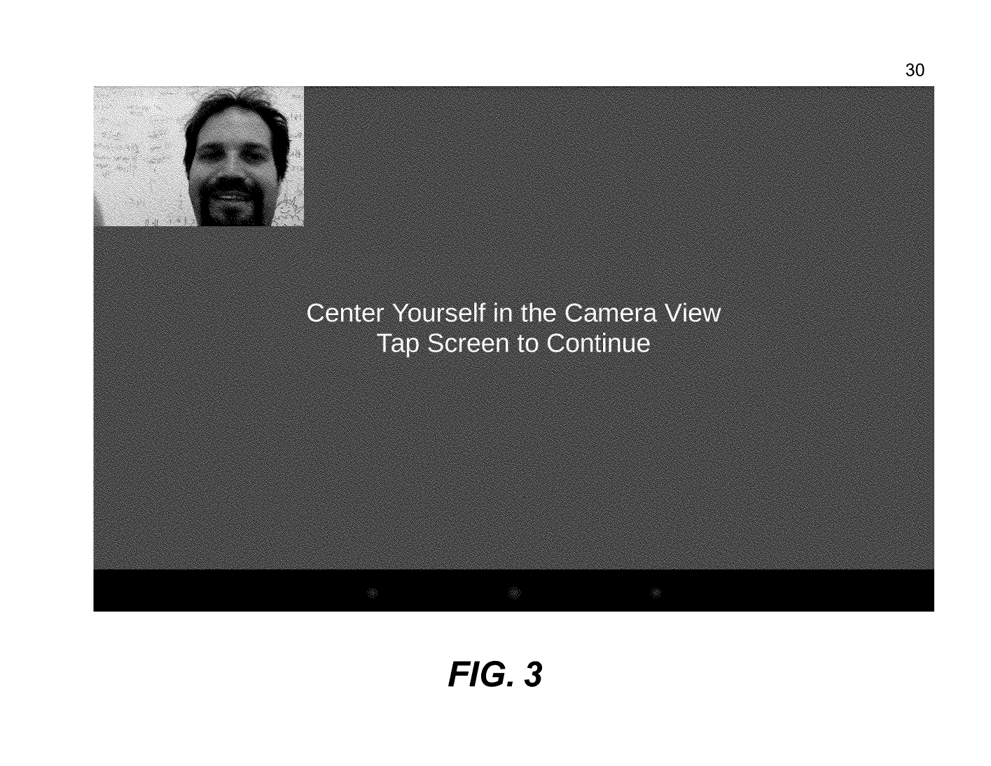

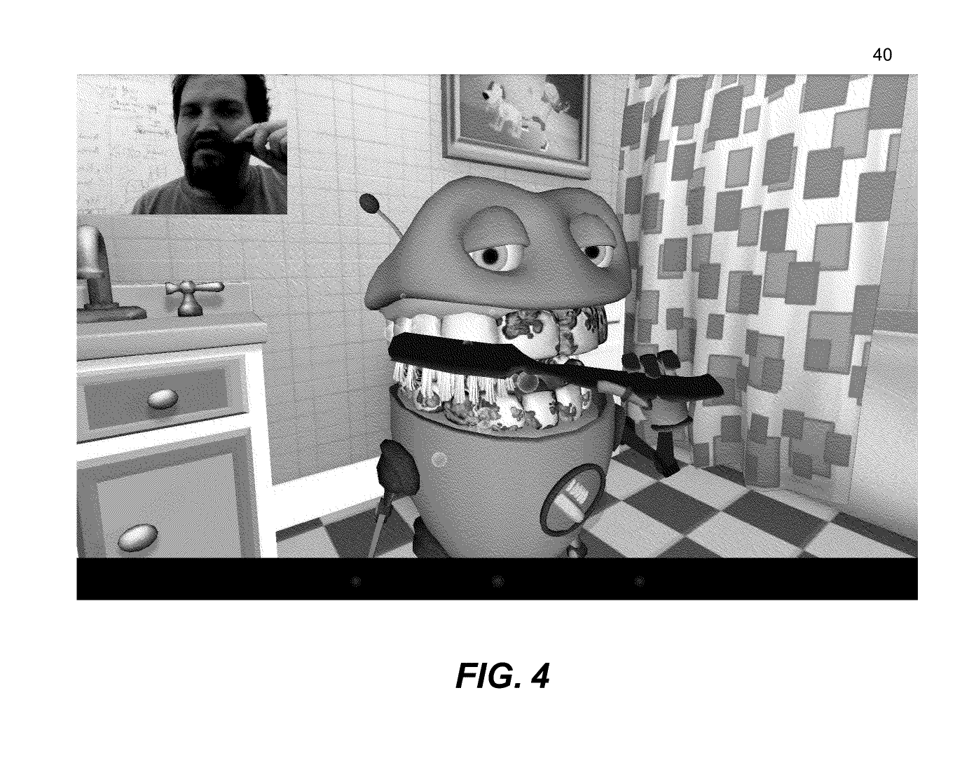

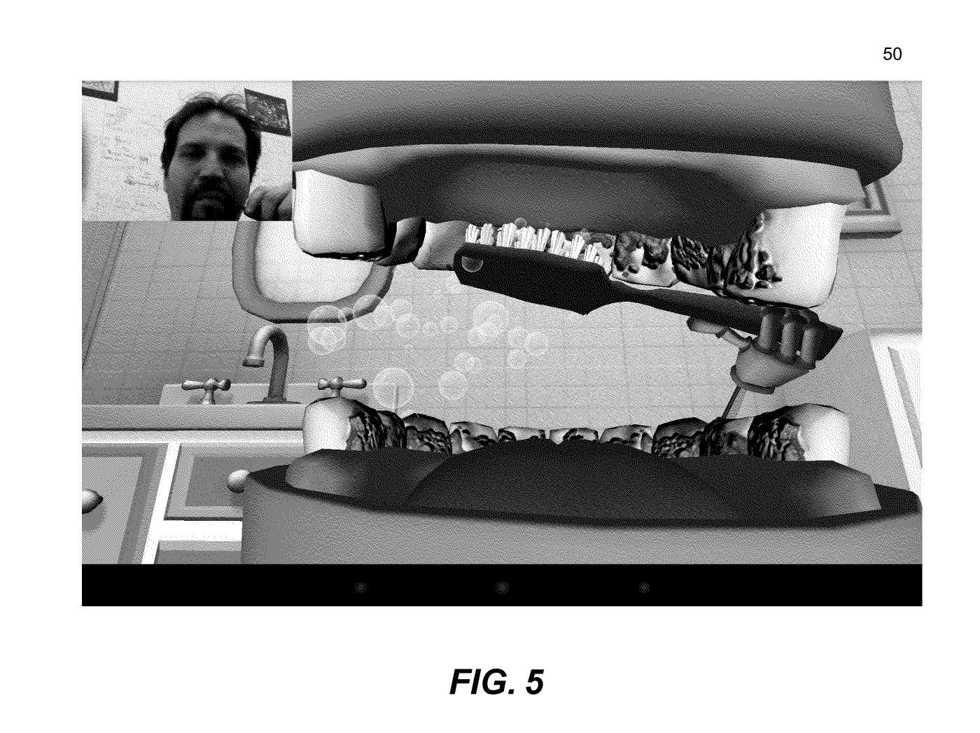

FIGS. 3-10 are screen shots of an illustrative toothbrush training game for children. FIG. 3 is a registration screen that the user utilizes to position the tablet and/or their body so that the user's face is located in the user viewing field. FIG. 4 shows the instructional character (“Mr. Molar”) running with the user's captured image displayed as a “picture within a picture.” FIG. 5 illustrates the separation of the instructional character's head to illustrate the desired toothbrush position and motion for a stroke on the inside surface of the user's teeth. This indicates how the instructional demonstration and the selfie video often most show different points of view. This continues through the complete tooth brushing routine, typically about two minutes covering each brushing surface and stroke for the desired number of strokes. Music is also played at the desired brushing tempo.

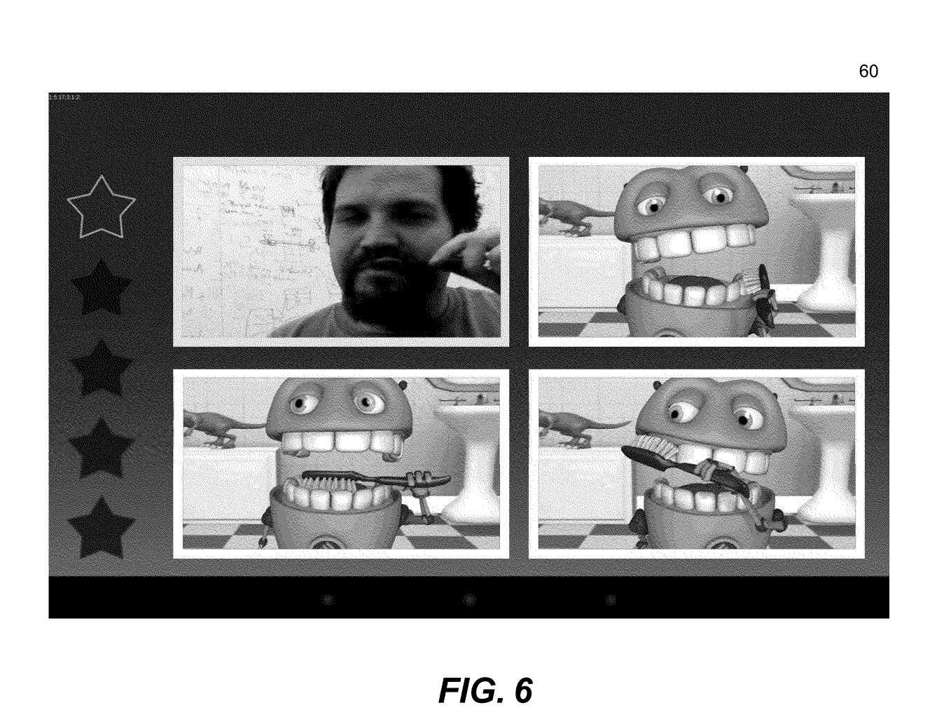

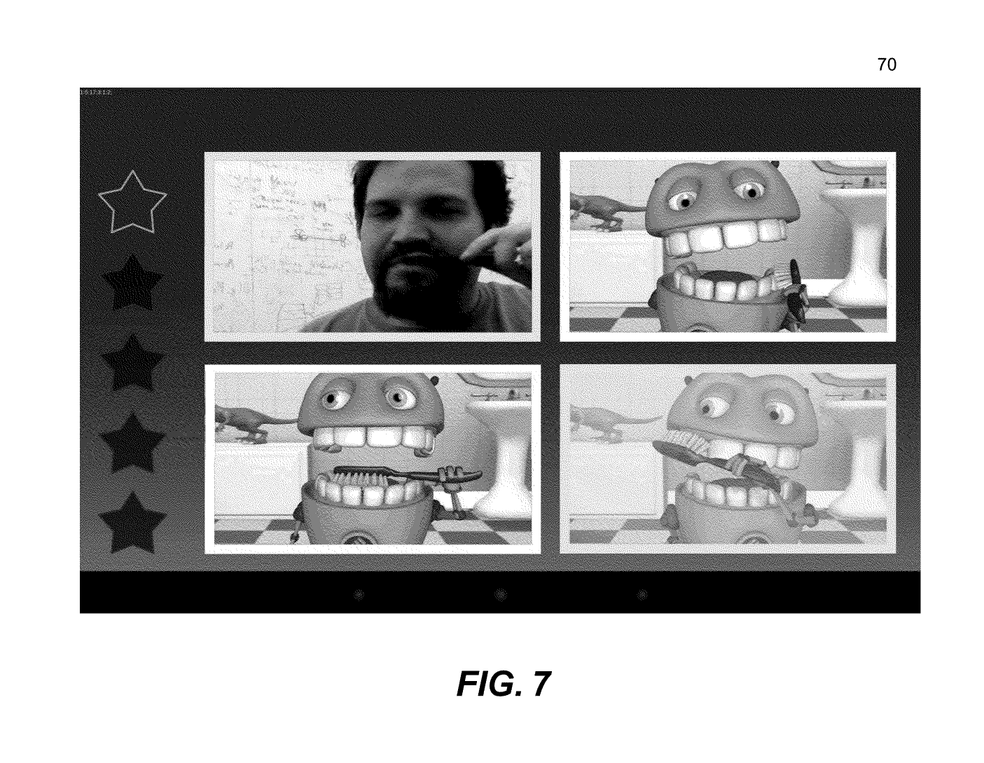

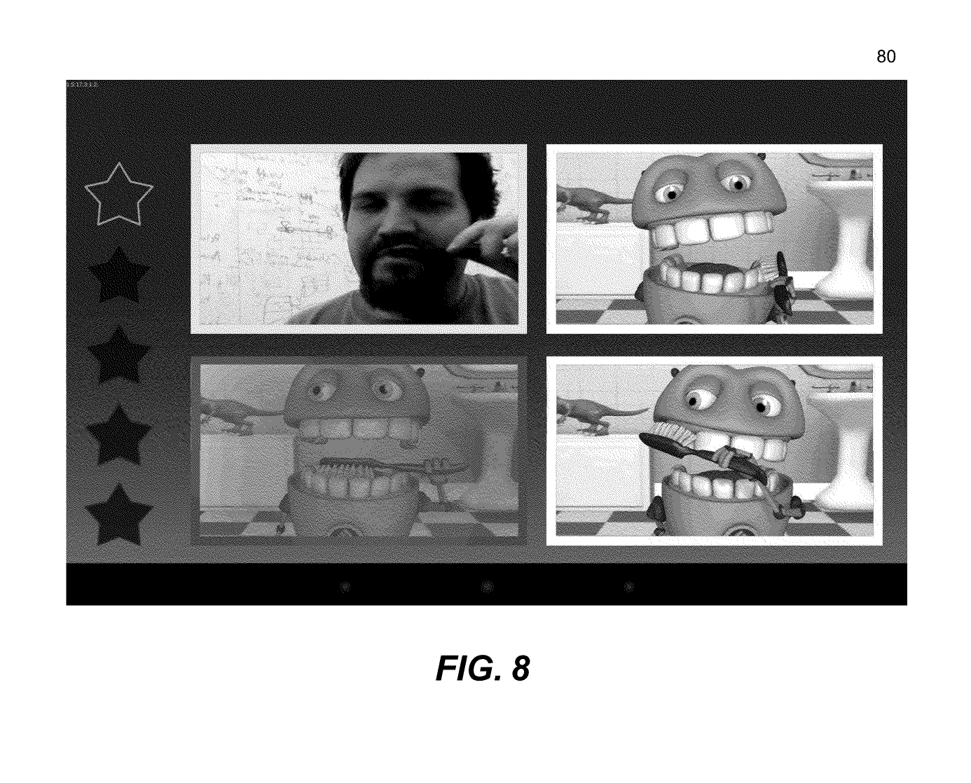

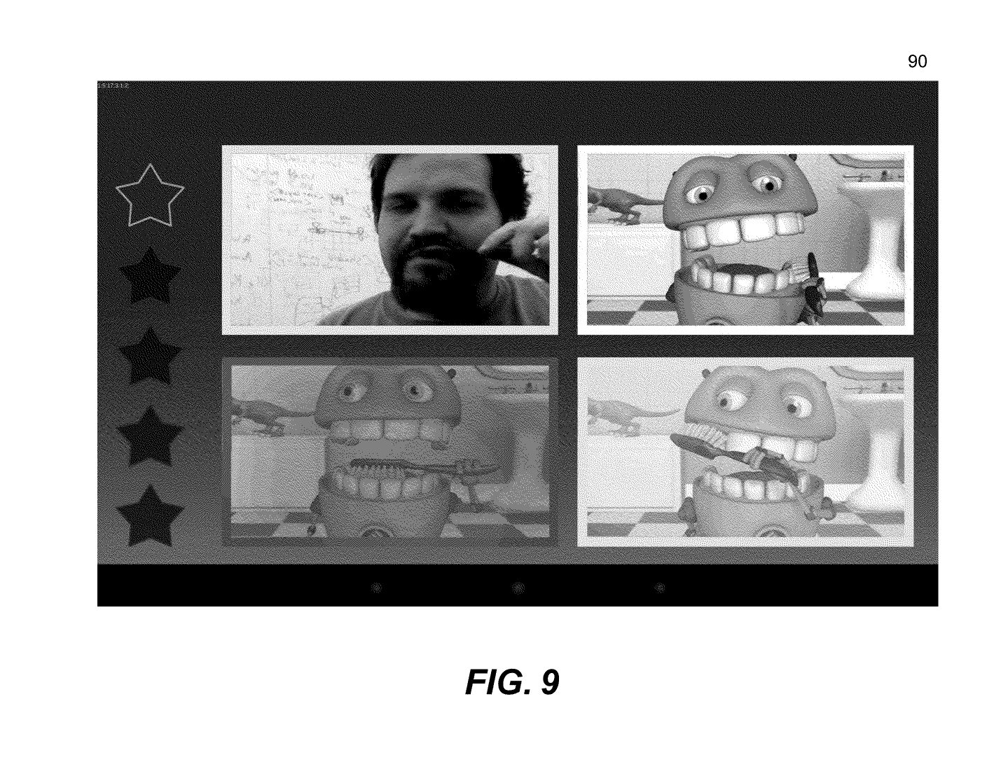

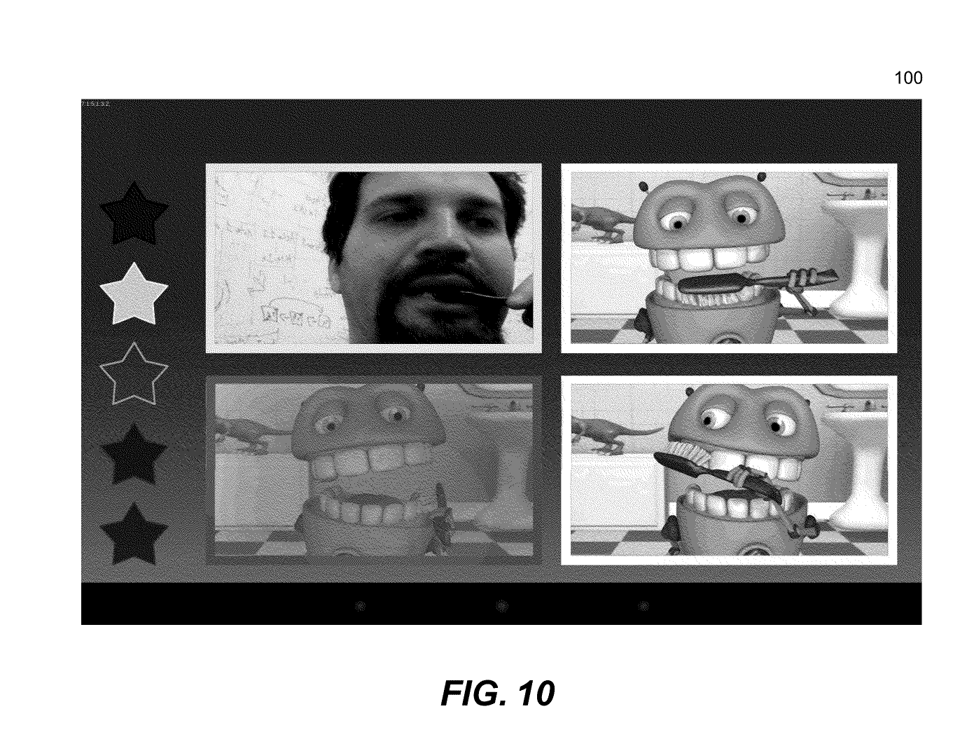

At the conclusion of the brushing routine, FIG. 6 illustrates on of the multiple-choice “matching” screens. Along the left side a star is displayed for each multiple-choice “matching” screen that will be displayed. FIG. 7 illustrates a user selection of the correct “matching” instructional image. FIG. 8, on the other hand, illustrates a user selection of an incorrect “matching” instructional image. FIG. 9 shows a correct selection following the incorrect selection of FIG. 8. FIG. 10 illustrated a later point in the scoring process where a “black star” indicates an “incorrect” response to the first “matching” question, a “gold star” illustrates a “correct” response to the second “matching” question, and the user is in the process of answering the third “matching” question.

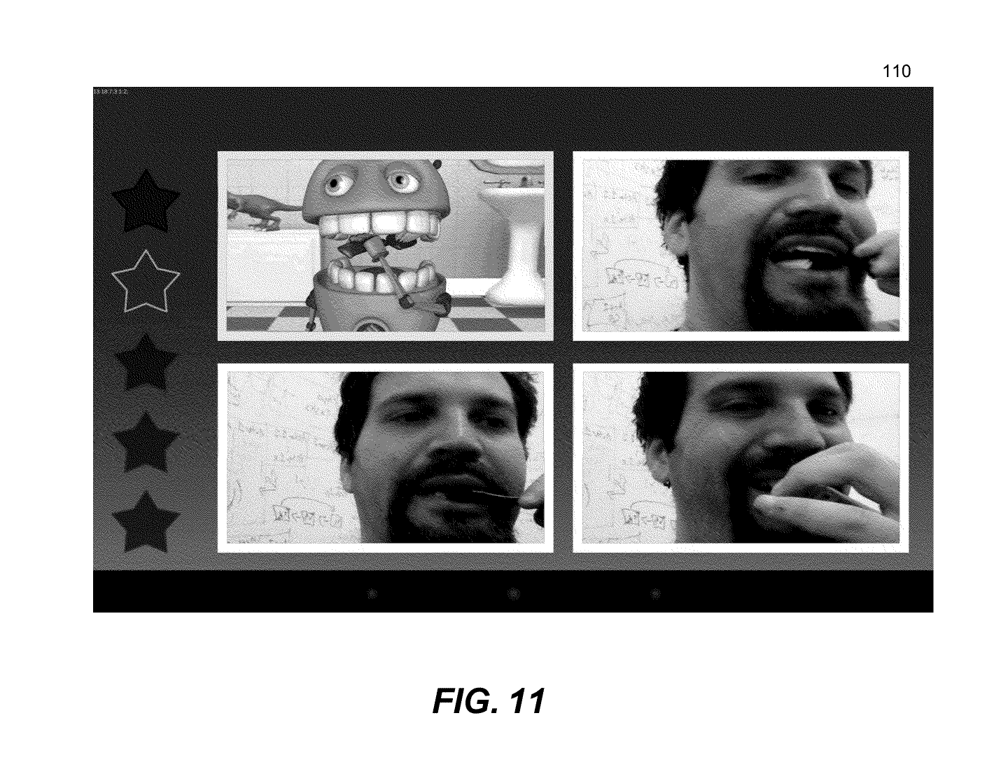

FIG. 11 illustrates an alternative “matching” question format in which the instructional character is shown as the exemplar in the upper left quadrant, and three multiple-choice images of the user and shown in the selection quadrants. Allowing the user to correctly match-up their tooth brush positions with the instructional images in a game-like format produces the desired effect of encouraging the children to mimic the instructional images. Game points, various electronic celebrations, and game character progression have been found to be effective motivation for children.

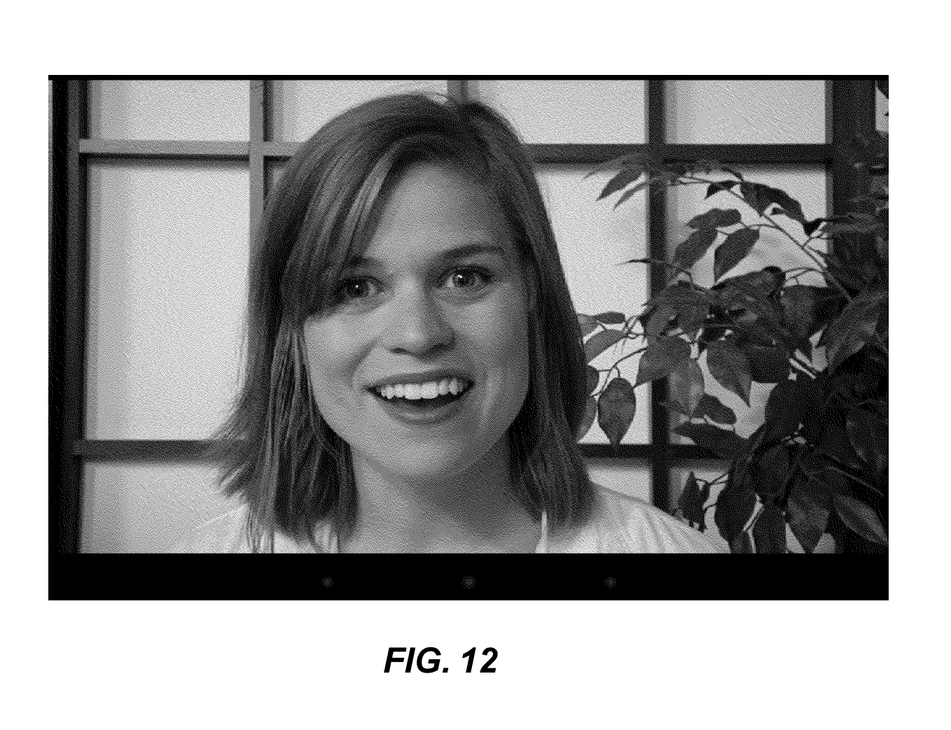

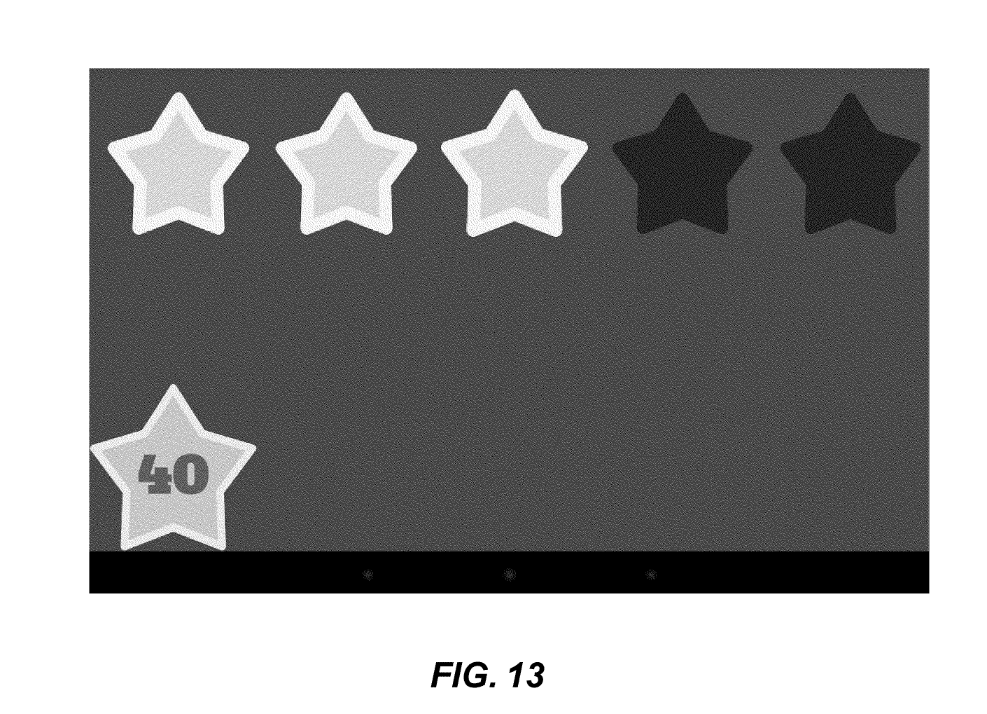

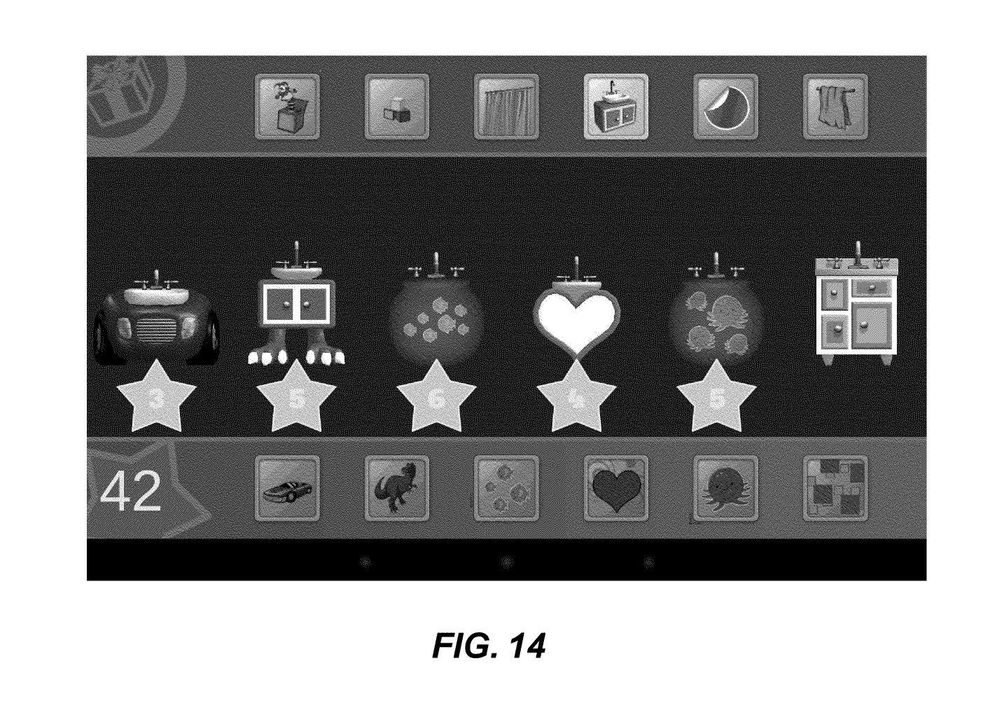

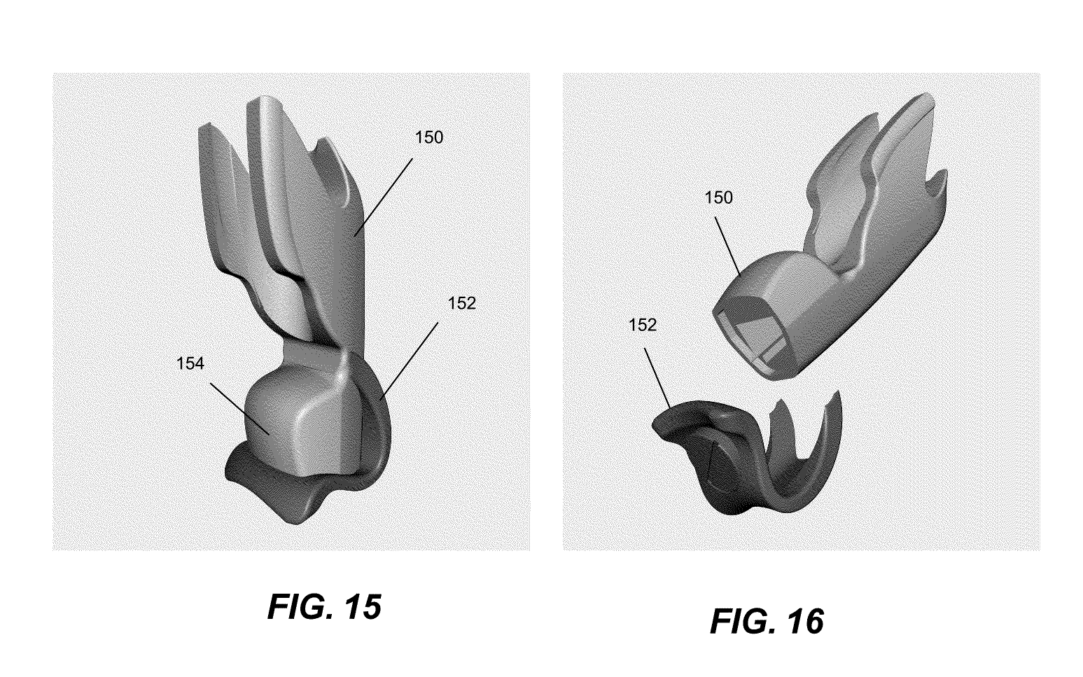

FIGS. 12-15 illustrate various types of game rewards. FIG. 12 shows a reward in recorded parental praise, which may be augmented with parental constructive criticism and correctional instruction for a poor brushing performance. FIG. 13 depicts a game point award that may be used in any suitable manner within the game system, for example to “purchase” an upgraded game avatar, playing time in another game application, or form the basis for a parental award provided outside the game system. FIG. 14 illustrates a “reward bank” game point redemption system in which electronic game pieces may be purchased and accumulated. FIG. 15 illustrates an electronic celebration on which Mr. Molar displays large, sparkling white teeth and expresses praise for a brushing job well done.

Another type of feedback that has been found to be particularly effective for children is to display the avatar's teeth bearing a heavy level of green debris (“gunk”) that is removed through successful completion of the desired brushing routine to produce the sparkling clean teeth. The sparkling feature may be much enhanced by video to encourage the children to brush properly until their teeth are nice and clean like Mr. Molar's. Many other audio-visual elements may encourage and reward successful completion of the brushing routine, such as triumphant music and special video effects. The successful brusher may be rewarded with the acquisition of points, medals, badges and other symbols of achievement, which are recorder for parental review and further reward as desired. Success may be accompanied by the “unlocking” of restricted game features such as advanced levels, desirable toothbrushes, and new music or avatars or by scene decoration items and in game accessories.

Gunk removal may also be depicted as a progression may be shown for different brushing surfaces depending on how well the user completed the desired cleaning operation for different brushing surfaces. The end result of the brushing routine, as illustrated by gunk removal levels on various brushing surfaces, may be displayed to the user in a post-routine review that may be stored for later review. The instructive program may highlight for the user the specific areas where the desired brushing routine was not completed properly and provide the user with the option of returning to go over those areas again. The instructive program may also store the date-stamped end result of each tooth brushing session, for example as depicted by iconic gunk removal images, or a full motion video clip, or as numeric performance statistics. These data can be presented in a variety of formats for review by a human brushing mentor (such as parent or oral health professional). These mentors can review an individual session in detail, or observe a longitudinal time-series to monitor the progress of the child's skill acquisition. Online systems allow these performance data to be shared outside the home, in compliance with relevant privacy regulations.

It should also be appreciated that different characters, feedback routines, songs, rewards and other elements may be tailored for children of different ages, training levels, and other demographic factors. As another option, these elements may be selected (mix and match) separately for each user to provide an individualized and adjustable routine for each user. As another option, Mr. Molar may be replaced by a customized avatar selected by and potentially resembling the specific user. Many other potential features and variations will become apparent to those skilled in the art one they become familiar with the basic element of the invention.

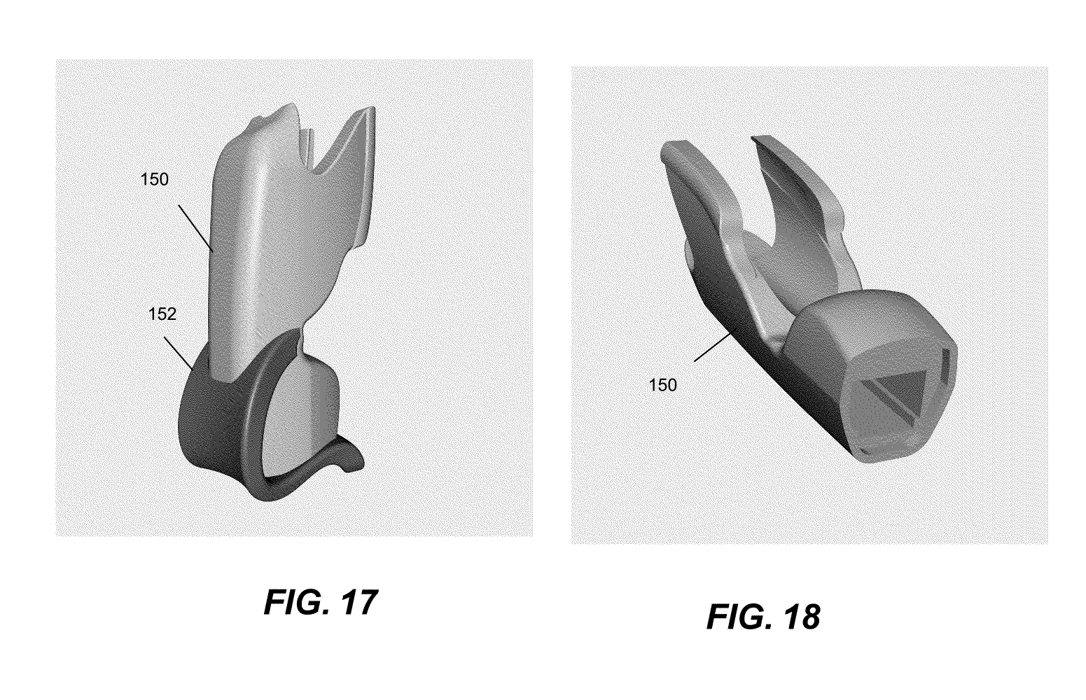

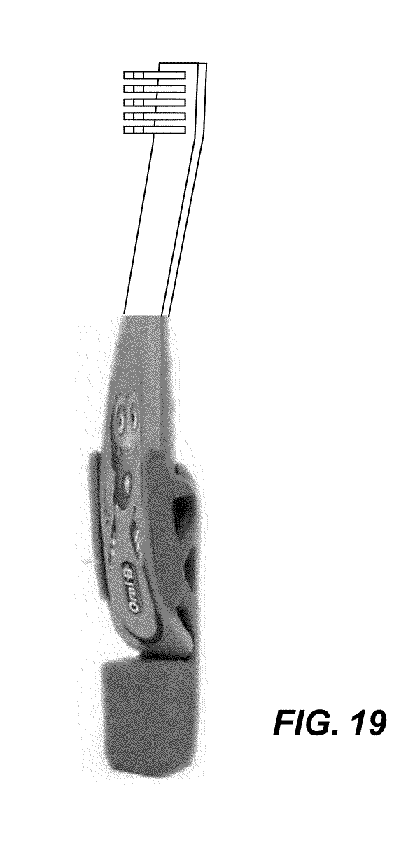

FIGS. 16-19 illustrate as clip-on instrumented handle for a non-instrumented toothbrush allowing it the function in an instrumented toothbrush monitoring and instructional system. This particular embodiment includes a clip-on handle body 150 and a stand 152 that clips onto the handle body. The stand 152 allows the toothbrush with the instrumented handle to stand upright on a horizontal surface as shown in FIG. 19. The stand also serves as cover for the battery case 154 of the handle body. The instrumented handle allows an ordinary, non-instrumented toothbrush to function as an instrumented handle in an instrumented toothbrush monitoring and instructional system, such as the system described in U.S. patent application Ser. No. 13/961,938 (Publication No. 2014-0065588 A1) which incorporated by reference.

The present invention may be implemented as a software application running on a general purpose computer including an app for a portable computing device, a software application running on a server system providing access to a number of client systems over a network, or as a dedicated computing system. As such, embodiments of the invention may consist (but not required to consist) of adapting or reconfiguring presently existing equipment. Alternatively, original equipment may be provided embodying the invention.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing

Computer program code for carrying out operations for aspects of the present invention may be written in any combination of one or more programming languages, including an object oriented programming language such as Java, Smalltalk, C++ or the like and conventional procedural programming languages, such as the “C” programming language or functional languages such as Lisp or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The invention is defined by the following claims, which should be construed to encompass one or more structures or function of one or more of the illustrative embodiments described above, equivalents and obvious variations.

1. A system for training a child to tooth brushing training system configured to appear to be a game to children, wherein:
the system creates or records a demonstration video illustrating a desired tooth brushing routine;
after the demonstration video has been created or recorded, the system captures video of a user during a tooth brushing routine and displays the captured video alongside the demonstration video illustrating the desired tooth brushing routine;
at the conclusion of the user's brushing routine, the system displays a series of instructional screens to the user, wherein each screen displays the user's position at a particular point in the user's brushing routine along with a plurality of instructional images from the demonstration video;
for each instructional screen, the system prompts the user to select an instructional image that corresponds to the user's displayed tooth brush position; and
the system awards points for selection of correct instructional images.

2. The tooth brushing training system of claim 1, wherein the demonstration video comprises recorded video.

3. The tooth brushing training system of claim 1, wherein the demonstration video comprises animated video.

4. The tooth brushing training system of claim 1, wherein each instructional screen is divided into quadrants and system displays a captured image of the user in one quadrant and instructional images in the other quadrants.

5. The tooth brushing training system of claim 1, wherein the system displays an electronic reward for a high score.

6. The tooth brushing training system of claim 5, wherein the electronic rewards comprises parental praise.

7. The tooth brushing training system of claim 1, wherein the demonstration video records a parental demonstration.

8. A method for training a child to tooth brushing training system configured to appear to be a game to children, comprising:
creating or recording a demonstration video illustrating a desired tooth brushing routine;
after the demonstration video has been created or recorded, capturing video of a user during a tooth brushing routine and displays the captured video alongside the demonstration video illustrating the desired tooth brushing routine;
at the conclusion of the user's brushing routine, displaying a series of instructional screens to the user, wherein each screen displays the user's position at a particular point in the user's brushing routine along with a plurality of instructional images from the demonstration video;
for each instructional screen, prompting the user to select an instructional image that corresponds to the user's displayed tooth brush position; and
awarding points for selection of correct instructional images.

9. The method of claim 8, wherein the demonstration video comprises recorded video.

10. The method of claim 8, wherein the demonstration video comprises animated video.

11. The method of claim 8, wherein each instructional screen is divided into quadrants and system displays a captured image of the user in one quadrant and instructional images in the other quadrants.

12. The method of claim 8, further comprising displaying an electronic rewards for a high score.

13. The method of claim 12, wherein the electronic rewards comprises parental praise.

14. The method of claim 8 wherein the demonstration video records a parental demonstration.

15. A non-transitory computer storage medium storing non-transitory, computer executable instructions for causing a computer to perform a method for training a child to tooth brushing training system configured to appear to be a game to children, comprising:
creating or recording a demonstration video illustrating a desired tooth brushing routine;
after the demonstration video has been created or recorded, capturing video of a user during a tooth brushing routine and displays the captured video alongside the demonstration video illustrating the desired tooth brushing routine;
at the conclusion of the user's brushing routine, displaying a series of instructional screens to the user, wherein each screen displays the user's position at a particular point in the user's brushing routine along with a plurality of instructional images from the demonstration video;
for each instructional screen, prompting the user to select an instructional image that corresponds to the user's displayed tooth brush position; and
awarding points for selection of correct instructional images.

16. The computer storage medium of claim 15, wherein the demonstration video comprises recorded video.

17. The computer storage medium of claim 15, wherein the demonstration video comprises animated video.

18. The computer storage medium of claim 15, wherein each instructional screen is divided into quadrants and system displays a captured image of the user in one quadrant and instructional images in the other quadrants.

19. The computer storage medium of claim 18, further comprising displaying an electronic rewards for a high score.

20. The computer storage medium of claim 15, wherein the electronic rewards comprises parental praise.
